(19) United States
(12) Patent Application Publication
(10) Pub. No.: US 2011/0309670 A1
(43) Pub. Date: Dec. 22, 2011

(54) Decorative rim

(76) Inventor: James Lee Taylor, Waco, TX (US)

(21) Appl. No.: 11/985,008

(22) Filed: Nov. 13, 2007

Related U.S. Application Data
(60) Provisional application No. 60/858,280, filed on Nov. 13, 2006.

(51) Int. Cl. B60B 3/10

(52) U.S. Cl. 301/64.101

(57) ABSTRACT

The present invention relates to decorative rims for self-propelled vehicles. The decorative rim is manufactured with a logo incorporated into the spokes of the rim spatially disposed within the decorative rim.

### BACKGROUND

This invention relates to decorative rims mounted onto wheels of vehicles. There are several patents that disclose decorative rims. For example, U.S. Pat. No. 4,280,293 discloses a decorative rim covering for a vehicle. However, the present invention discloses a uniquely designed decorative rim.

The present invention relates to decorative rims for self-propelled vehicles. The decorative rim is manufactured with a logo incorporated into the spokes of the rim spatially disposed within the decorative rim. The rim can be divided into upper and lower quadrant. The logo can be incorporated into the upper or lower quadrant of the rim.

Other objects and advantages of the present invention will become apparent from the following detailed description when viewed in conjunction with the accompanying drawings, which set forth certain embodiments of the invention.

### BRIEF DESCRIPTION OF DRAWINGS

FIG. 1 is front view of a rim for a vehicle, showing one embodiment.

FIG. 2 is front view of a rim for a vehicle, showing an alternative embodiment.

FIG. 3 is front view of a rim for a vehicle, showing an alternative embodiment.

FIG. 4 is side view of each embodiment shown.

FIGS. 5, 6 and 7 are front views of alternative embodiments of the present invention.

### DETAILED SPECIFICATIONS

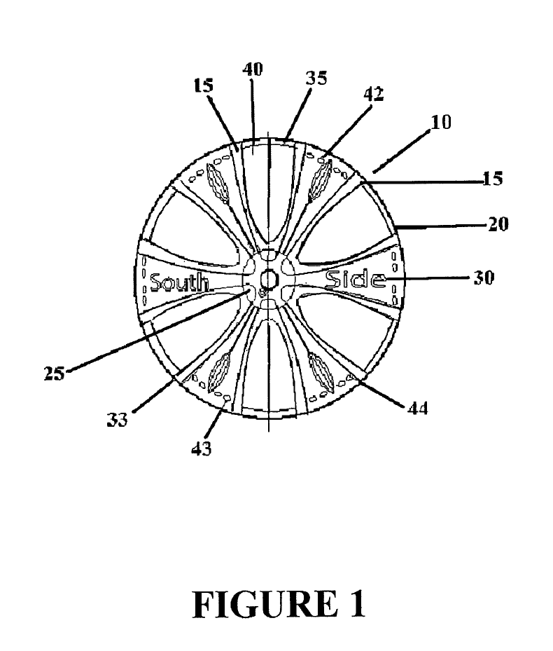

Referring to FIG. 1, there is shown a manufactured decorative rim broadly designated as numeral 10, adapted to be mounted onto a wheel of a vehicle assembly normally comprising a tire mounted onto a disk and rim unit (10). Only the decorative rim unit (10) is shown. The present invention is a decorative rim for any type of wheel for a self-propelled vehicle. The decorative rim is generally made of a durable metal material such as steel, aluminum or another suitable material. Aluminum wheels are lighter and more impact absorbent.

As shown, decorative rim (10) comprises a plurality of spokes (15) internally spaced within the rim. Each spoke extend from the peripheral edge (20) into the center (25) of decorative rim (10). The rim (10) is further defined by horizontal axis (30) and the vertical axis (35). Rim (10) is further divided into upper quadrant 32 and lower quadrant 33. Upper quadrant 32 is further subdivided into left upper quadrant 40, right upper quadrant 42. Lower quadrant 33 is subdivided into left lower quadrant 43, and right lower quadrant 44.

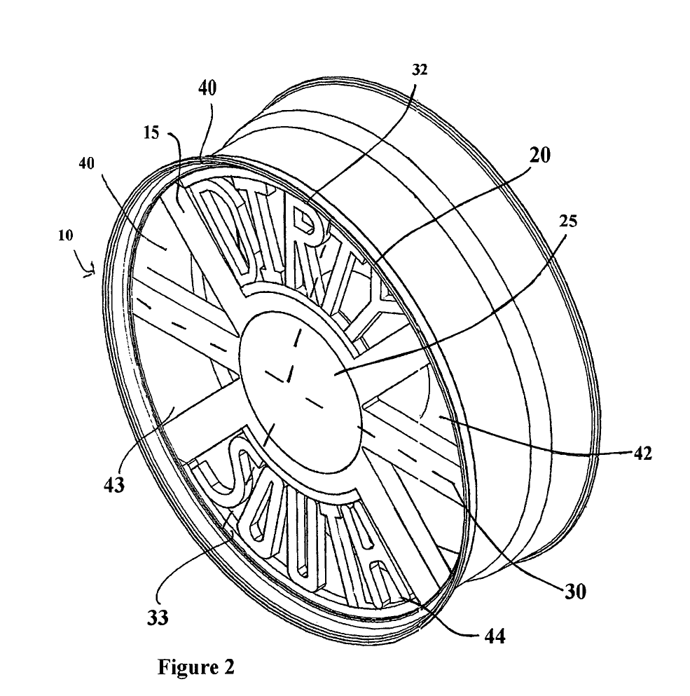

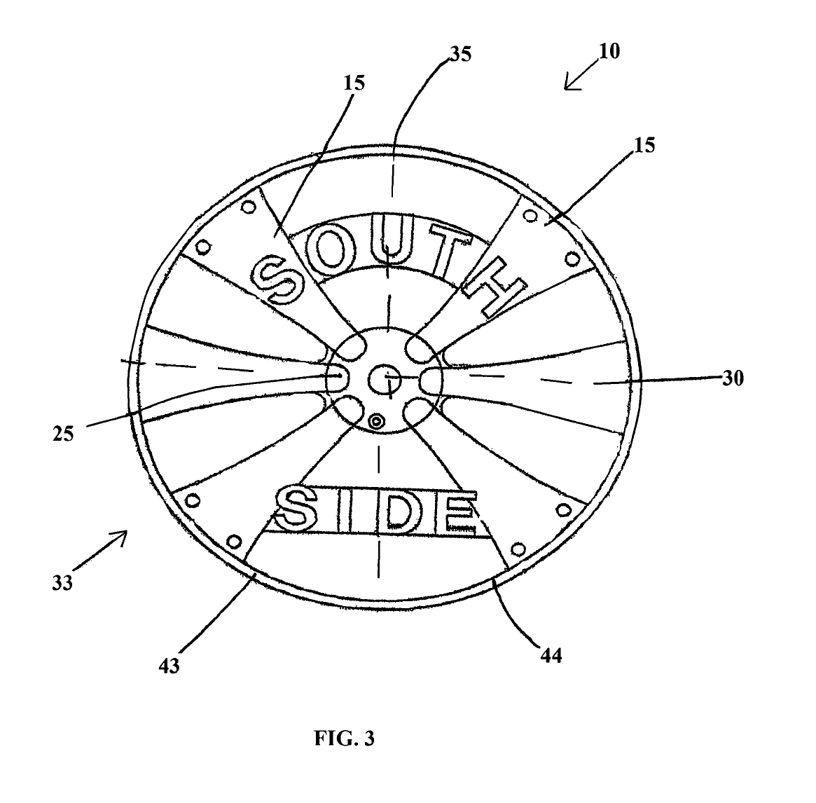

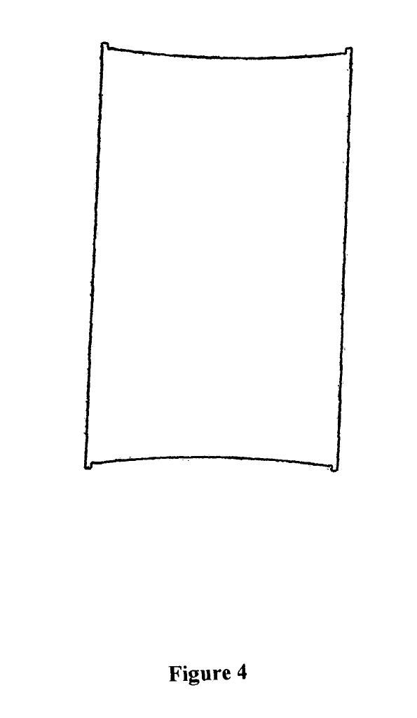

As shown in FIGS. 1, 2, and 3 decorative wording logo can be incorporated extending fully or partially across the horizontal axis (30). Additionally, the decorative wording logo can be incorporated across the upper quadrant or lower quadrant. Alternatively, the decorative wording can be incorporated within a single quadrant (i.e. left upper quadrant 40, right upper quadrant 42, left lower quadrant 43, and right lower quadrant 44). Alternatively, the logo can be incorporated into any combination or permutation thereof. As shown, the decorative logo can be incorporated between or within spokes 15.

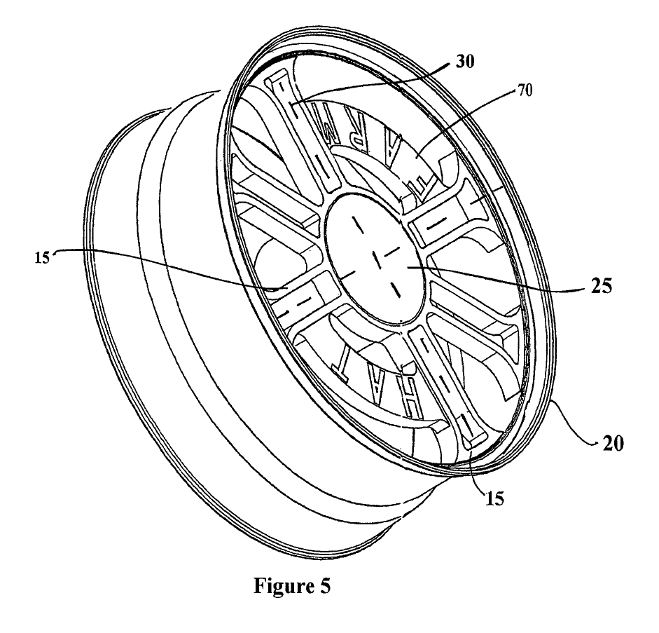

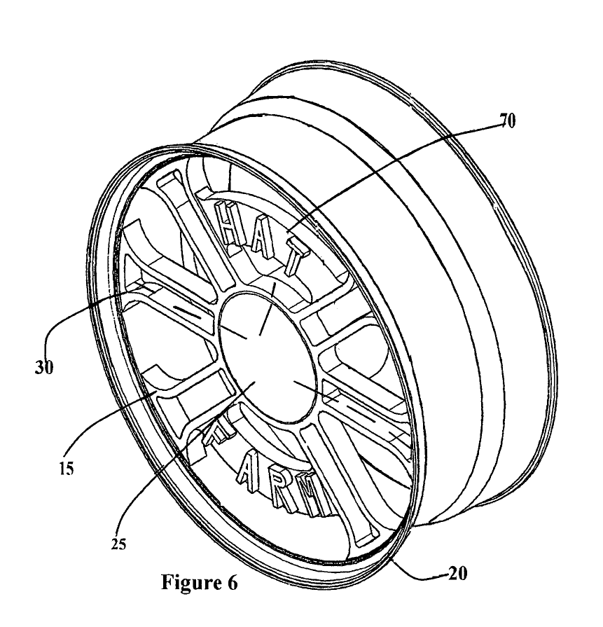

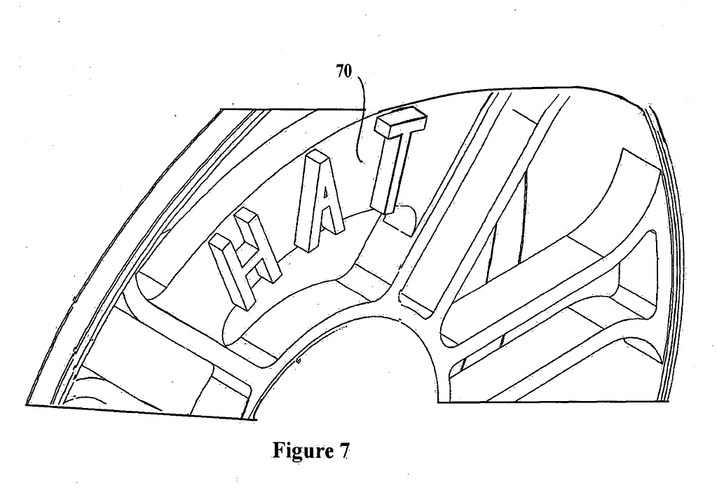

As depicted in FIGS. 5, 6, and 7, the indicia means is incorporated into the support member that is disposed within the spokes 15 at a predetermined location. In one embodiment, the support member 70 further comprises an upper brace and a lower brace in which the indicia means is situated in a suspended state between the upper and lower brace. In an alternative embodiment the support member 70 further comprises a bar with the indicia means being raised upon the external surface area of the bar. In yet another embodiment the support member 70 further include a bar with the indicia means being engraved within the external surface area of the bar member. Here, engraved means the letters or symbols or designs are embedded within the surface area of the bar. However, raised means the letters, symbols or designs are raised above the surface area of the bar. To further decorate the rim, the external surface area of the central portion 25 of the rim can also be adapted with a indicia means that is engraved or raised.

What is claimed is:

1. A specially manufactured decorative rim, the rim comprising:
a circular portion having a plurality of spokes internally disposed therein. the circular portion having a central portion and being circumferentially surrounded by a plurality of spokes;
a peripheral edge circumferentially surrounding the plurality of spokes;
each spoke extending from the central portion to the peripheral edge;
a decorative logo having indicia means incorporated within a support member,
and the support member being disposed at a predetermined location within the plurality of spokes

2. The decorative rim of claim 1 further comprising:
a horizontal axis extending across the diameter of the circular portion wherein the circular portion is divided into an upper quadrant and a lower quadrant.

3. The decorative rim of claim 2 further comprising:
a vertically axis extending across the diameter of the circular portion wherein the circular portion is divided into a left quadrant and a right quadrant.

4. The decorative rim of claim 2 wherein the support member is disposed across, between or within the spokes in the upper quadrant.

5. The decorative rim of claim 2 wherein the support member is disposed across, between or within the spokes in the lower quadrant.

6. The decorative rim of claim 3 wherein the support member is disposed across, between or within the spokes in the left quadrant.

7. The decorative rim of claim 3 wherein the support member is disposed across, between or within the spokes in the right quadrant.

8. The decorative rim of claim 3 wherein the circular portion is further subdivided into an upper left quadrant, an upper right quadrant, a lower left quadrant, and a lower right quadrant.

9. The decorative rim of claim 8 wherein the support member is disposed across, between or within the spokes in the upper left quadrant.

10. The decorative rim of claim 8 wherein the support member is disposed across, between or within the spokes in the upper right quadrant.

11. The decorative rim of claim 8 wherein the support member is disposed across, between or within the spokes in the lower left quadrant.

12. The decorative rim of claim 8 wherein the support member is disposed across, between or within the spokes in the lower right quadrant.

13. The decorative rim of claim 1 wherein the central portion further comprises an external surface area with indicia means engraved therein.

14. The decorative rim of claim 1 wherein the central portion further comprises an external surface area with indicia means being raised thereon.

15. The decorative rim of claim 1 wherein the support member further comprises an upper brace and a lower brace with the indicia means situated therebetween

16. The decorative rim of claim 1 wherein the support member further comprises a bar with an external surface area with the indicia means being raised thereon.

17. The decorative rim of claim 1 wherein the support member further comprises a bar with an external surface area with the indicia means being engraved therein.

18. A specially manufactured decorative rim, the rim comprising:
a circular portion having a plurality of spokes internally disposed therein. the circular portion having a central portion and being circumferentially surrounded by a plurality of spokes;
a peripheral edge circumferentially surrounding the plurality of spokes;
each spoke extending from the central portion to the peripheral edge;
a decorative logo having indicia means incorporated within a support member,
the support member being disposed at a predetermined location within the plurality of spokes;
the support member further comprising an upper brace and a lower brace extending the length of indicia means;
and the indicia means situated between the upper and lower brace in a suspended state.
